(19) United States
(12) Patent Application Publication
(10) Pub. No.: US 2014/0375873 A1
(43) Pub. Date: Dec. 25, 2014

(54) OPTICAL DEVICE

(71) Applicants: Sintai Optical (Shenzhen) Co., Ltd, Shenzhen City (CN); Asia Optical International Ltd., Tortola (GB)

(72) Inventors: Takamasa Sakamoto, Shenzhen (CN); Chun-Hung Huang, Taichung (TW)

(73) Assignees: Sintai Optical (Shenzhen) Co., Ltd., Shenzhen City (CN); Asia Optical International Ltd., Tortola (GB)

(21) Appl. No.: 14/314,524

(22) Filed: Jun. 25, 2014

(30) Foreign Application Priority Data
Jun. 25, 2013 (TW) 102122477

(51) Int. Cl. H04N 5/232; G03B 13/36

(52) U.S. Cl. CPC H04N 5/23212; G03B 13/36; H04N 5/23296
USPC 348/351

(57) ABSTRACT

An optical device includes a base; an image sensing element disposed on the base; a focusing motor connected to a frame and mounted on the base by the frame; a barrel adjacent to the base, wherein the focusing motor and the frame are disposed within the barrel; and a first lens group disposed within the barrel, having at least one first lens and connecting to the focusing motor. In operation, the focusing motor drives the first lens group to approach or move away from the image sensing element so that the light is focused on the image sensing element via the first lens group.

### RELATED APPLICATION

This application claims the benefit of foreign priority to Taiwan Invention Patent Application No. 102122477, filed on Jun. 25, 2013, the entire contents of which are incorporated herein by reference for all purposes.

### BACKGROUND OF THE INVENTION

1. Field of the Invention

The invention relates to an optical device, and more particularly to an optical device having a focusing motor disposed on a base bearing an image sensing element.

2. Description of the Related Art

In general, typical cameras have zooming and focusing functions. The zooming function is to change a total focal length of an optical lens to shoot an object based on its distance. The focusing function is to regulate the focus length of the optical lens to allow light focused on an image sensing element such as charged coupled device (CCD), whereby a clear image can be caught.

For cameras having auto-zooming and auto-focusing functions, the auto-zooming function is accomplished by a zooming motor which rotates a rotational barrel so as to change a distance between a lens group in the rotational barrel and other lens groups, thereby changing the total focal length. The auto-focusing function is accomplished by a focusing motor which moves a lens group, thereby regulating the focus length to focus all light through the optical lens onto the image sensing element. FIGS. 1A and 1B depict the auto-zooming, and auto-focusing structure of a conventional camera, wherein a focusing motor 640 is mounted on an outer periphery of a barrel 620 or mounted on a frame 641 which is disposed on the outer periphery of a barrel 620 and fixed to a base 610. Also, a zooming motor 630 is disposed on the base 610.

### BRIEF SUMMARY OF THE INVENTION

The invention provides an optical device. The optical device in accordance with an exemplary embodiment of the invention includes a base; an image sensing element disposed on the base; a focusing motor connected to a frame and mounted on the base by the frame; a barrel adjacent to the base, wherein the focusing motor and the frame are disposed within the barrel; and a first lens group disposed within the barrel, having at least one first lens and connecting to the focusing motor. In operation, the focusing motor drives the first lens group to approach or move away from the image sensing element so that the light is focused on the image sensing element via the first lens group.

In another exemplary embodiment, the optical device further includes a second lens group connected to the barrel and disposed within the barrel.

In yet another exemplary embodiment, the optical device further includes a second lens group having at least one second lens, wherein light passes through the second lens group and the first lens group sequentially to reach the image sensing element.

In another exemplary embodiment, the optical device further includes a rotational barrel disposed around the barrel, wherein the rotational barrel rotates to move the first lens group and the second lens group along an inner periphery of the barrel to change the distance between the first lens group and the second lens group so as to change a total focal length of the first and second lens groups.

In yet another exemplary embodiment, the optical device further includes a zooming motor disposed on the base and connected to the rotational barrel, wherein the zooming motor rotates the rotational barrel.

In another exemplary embodiment, the base includes a mounting portion disposed in the barrel, and the focusing motor is disposed on the mounting portion.

In yet another exemplary embodiment, the base further includes a main body, the image sensing element is disposed on the main body, and the mounting portion protrudes from the main body vertically and integrated with the main body.

In another exemplary embodiment, the base includes a main body on which the image sensing element is disposed and a mounting portion on which the focusing motor is disposed via the frame, and the mounting portion protrudes from the main body vertically and integrated with the main body.

In yet another exemplary embodiment, the optical device is a video camera or a still camera.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a perspective view of an auto-zooming and auto-focusing structure of a conventional camera;

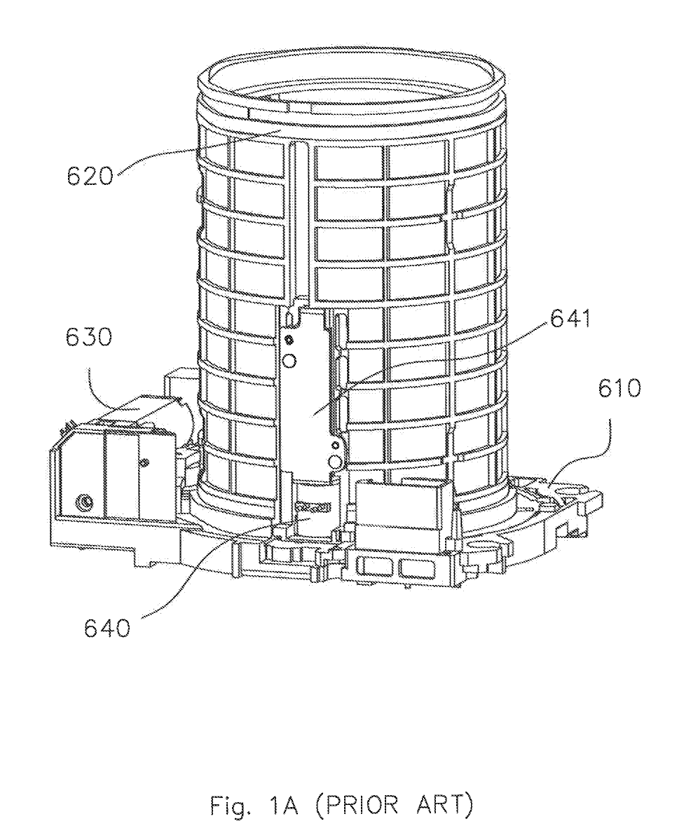

FIG. 1B is a perspective view of a conventional focusing motor;

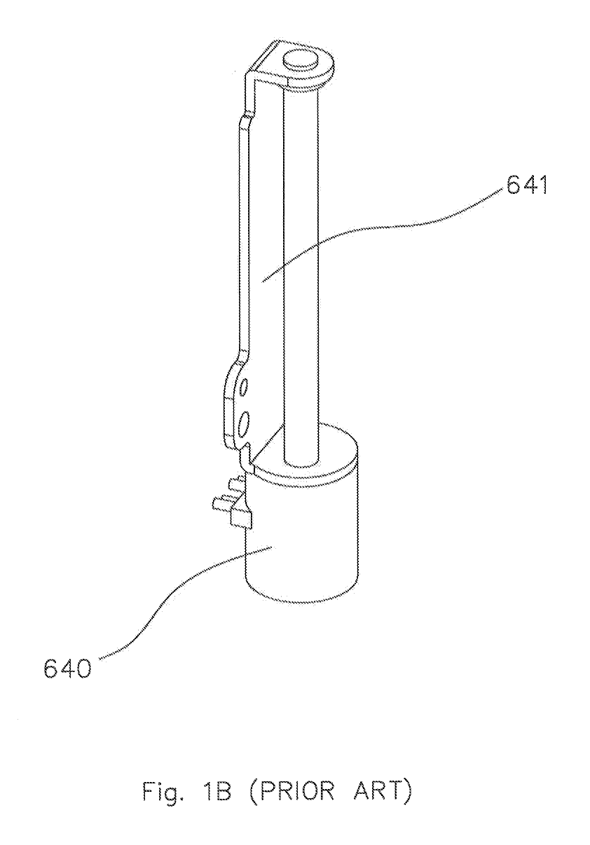

FIG. 2 is a perspective view of an embodiment of an optical device of the invention;

FIG. 3 is a partial cross section of an embodiment of an optical device of the invention;

FIG. 4 is a partially exploded view of an embodiment of an optical device of the invention; and

FIG. 5 is an exploded view of an embodiment of an optical device of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

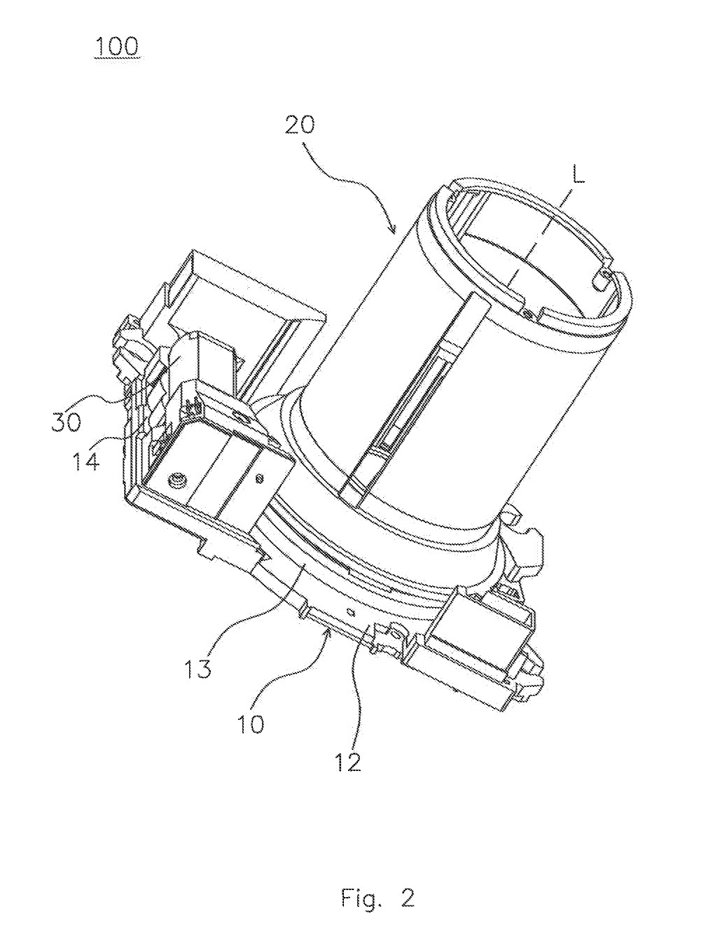

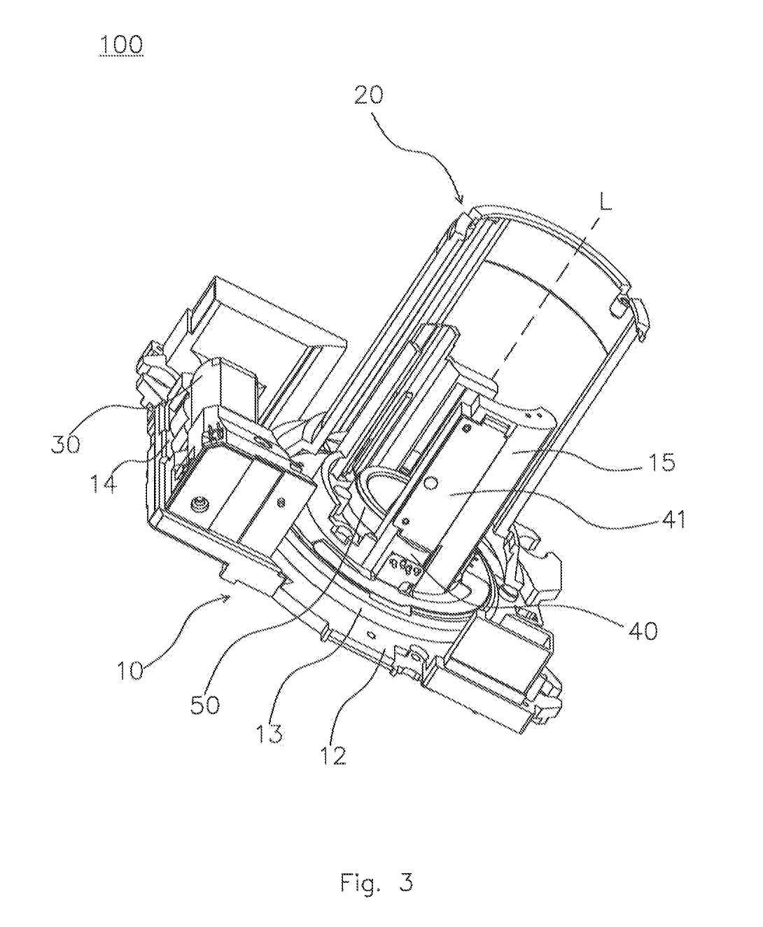

Referring to FIGS. 2 and 3, a camera is taken as an example for describing an optical device 100 of the invention, which includes a base 10, a barrel 20, a zooming motor 30, a focusing motor 40 and a lens frame 50. A first lens group (not shown) includes at least one first lens (not shown) disposed on the lens frame 50, and a second lens group (not shown) includes at least one second lens (not shown) disposed on other lens frame (not shown). Light passes through the second lens group and the first lens group sequentially to reach the base 10.

The base 10 includes a main body 12 which is planar. The main body 12 has a raised portion 13 which has a disc shape. A U-shaped seat 14 is disposed besides the raised portion 13 (on the left side of the FIGS. 2 and 3). A mounting portion 15 extends vertically from the raised portion 13 and is parallel to an axis L of the raised portion 13. The main body 12, the raised portion 13, the seat 14 and the mounting portion 15 may be integrated. The zooming motor 30 is mounted on the seat 14. The focusing motor 40 along with the frame 41 are fixed to the mounting portion 15 via screws. An image sensing element (not shown) is disposed on the center of the raised portion 13. The axis L extends through the image sensing element. In operation, light passes through the second lens group and the first lens group in sequence to reach the image sensing element. The image sensing element may be a charge-coupled device (CCD).

The barrel 20 is disposed near the raised portion 13 and surrounds the mounting portion 15. That is, the mounting portion 15 is disposed within the barrel 20. The focusing motor 40 fixed to the mounting portion 15 is also disposed within the barrel 20. An axis of the barrel 20 is parallel to the axis L, and several rotational barrels (not shown) are disposed outside the barrel 20. In operation, the zooming motor 30 rotates the rotational barrel, and the rotational barrel moves the lens frame 50 and other lens frames along the axis L under constraint of the barrel 20 to linearly approach or move away from the base 10.

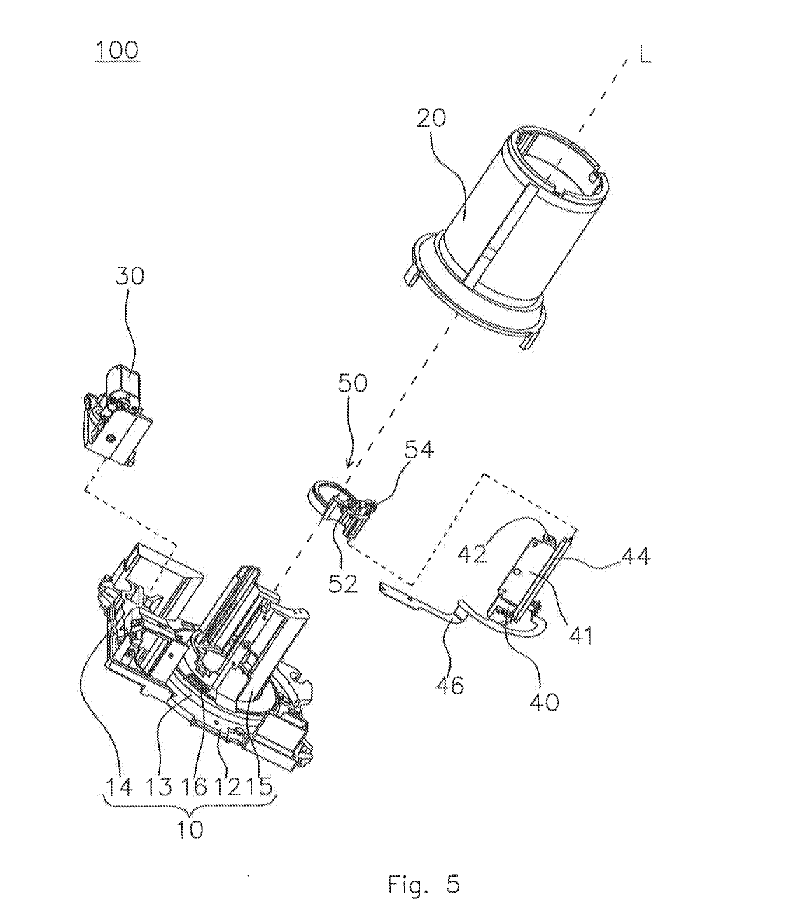

Referring to FIGS. 2-5, the lens frame 50 is connected to the focusing motor 40 and disposed within the barrel 20 and near the image sensing element. The first lens group (not shown) has at least one first lens (not shown) and is disposed on the lens frame 50. The focusing motor 40 moves the lens frame 50 along the axis L to linearly approach or move away from the image sensing element.

As described, light passes through the second lens group and the first lens group sequentially to reach the image sensing element. The total focal length of the first and second lens groups is changed to catch the images of objects at different distances when the zooming motor 30 moves the barrel 20 along the axis L to change the distance between the first lens group and the second lens group in zooming operation. Further, the distance between the lens frame 50 and the image sensing element (i.e. the distance between the first lens group and the image sensing element) is little adjusted to focus light, which passes through the first lens group, on the image sensing element when the focusing motor 40 moves the lens frame 50 along the axis L in focusing operation.

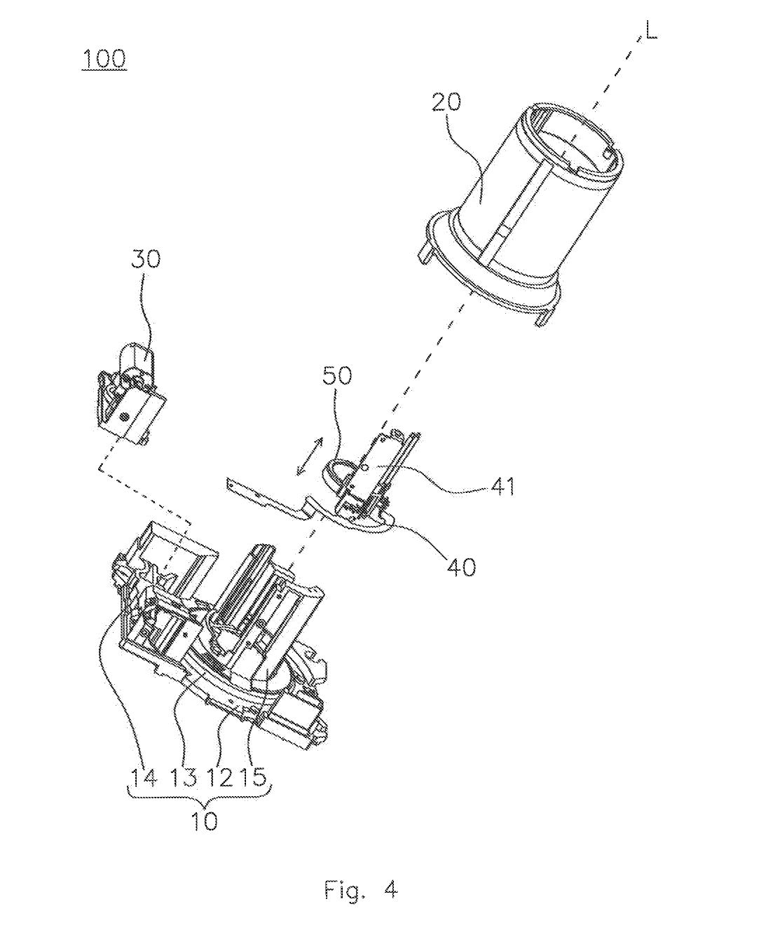

FIGS. 3 and 4 depict the structure of the lens frame 50 joined to the focusing motor 40. A shaft hole 52 and a rail hole 54 are formed on the lens frame 50. The shaft hole 52 and the rail hole 54 respectively correspond to a shaft 42 of the focusing motor 40 and the rail 44. The shaft 42 extends through the shaft hole 52. The rail 44 extends through the rail hole 54 and parallels the axis L. The shaft 42 has threads engaging the shaft hole 52, whereby the lens frame 50 is moved along the rail 44 by rotation of the shaft 42. The focusing motor 40 is fixed to the mounting portion 15 via screws, while the focusing motor 40 has an extension element 46 which extends through a mounting hole 16 of the raised portion 13 and is fixed to the base 10.

A camera is described as an example, but the optical device of the invention is not limited thereto. To the contrary, any optical device having structure of a focusing motor disposed on a base which bears an image sensing element belongs to the scope of the invention.

As the focusing motor 40 is directly disposed on the base 10, no other means for connection is required, and the amount of elements is reduced. Besides, the focusing motor 40 is disposed within the barrel 20 that occupies less space as compared to the conventional structure in which the focusing motor is disposed outside the barrel. Therefore, the optical device 100 of the invention is more impact than the conventional structure. In addition, as the focusing motor 40 is directly disposed on the base 10 of the image sensing element, the accumulation of tolerances during assembly is significantly reduced and the manufacturing process is simplified.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical device, comprising:
a base;
an image sensing element disposed on the base;
a focusing motor connected to a frame and mounted on the base by the frame;
a barrel adjacent to the base, wherein the focusing motor and the frame are disposed within the barrel;
a first lens group disposed within the barrel, comprising at least one first lens and connecting to the focusing motor, wherein the focusing motor drives the first lens group to approach or move away from the image sensing element so that light is focused on the image sensing element through the first lens group.

2. The optical device as claimed in claim 1 further comprising a second lens group connected to the barrel and disposed within the barrel.

3. The optical device as claimed in claim 1 further comprising a second lens group which comprises at least one second lens, wherein the light passes through the second lens group and the first lens group sequentially to reach the image sensing element.

4. The optical device as claimed in claim 2 further comprising a rotational barrel disposed around the barrel, wherein the rotational barrel rotates to move the first lens group and the second lens group along an inner periphery of the barrel to change a distance between the first lens group and the second lens group so as to change a total focal length of the first and second lens groups.

5. The optical device as claimed in claim 4 further comprising a zooming motor disposed on the base and connected to the rotational barrel, wherein the zooming motor rotates the rotational barrel.

6. The optical device as claimed in claim 2, wherein the base comprises a mounting portion disposed in the barrel, and the focusing motor is disposed on the mounting portion.

7. The optical device as claimed in claim 6, wherein the base further comprises a main body, the image sensing element is disposed on the main body, and the mounting portion protrudes from the main body vertically and integrated with the main body.

8. The optical device as claimed in claim 1, wherein the base comprises a main body on which the image sensing element is disposed and a mounting portion on which the focusing motor is disposed via the frame, and the mounting portion protrudes from the main body vertically and integrated with the main body.

9. The optical device as claimed in claim 1, wherein the optical device is a video camera.

10. The optical device as claimed in claim 1, wherein the optical device is a still camera.
